(19) United States
(12) Patent Application Publication
(10) Pub. No.: US 2014/0291979 A1
(43) Pub. Date: Oct. 2, 2014

(54) CONNECTION ASSEMBLY FOR AIR SUPPLY DEVICE

(71) Applicant: CAREMED SUPPLY INC., New Taipei City (TW)

(72) Inventor: Pao Ming SHIH, Taipei City (TW)

(73) Assignee: CAREMED SUPPLY INC., New Taipei City (TW)

(21) Appl. No.: 13/854,749

(22) Filed: Apr. 1, 2013

(51) Int. Cl. F16L 39/00

(52) U.S. Cl. CPC F16L 39/00
USPC 285/120.1

(57) ABSTRACT

A connection assembly includes a connector and a coupler. The connector has a housing member, which is provided on an end with a plurality of air inlet pipes, one of which is a blocked pipe while all other ones are open pipes, and on another end with an air outlet pipe connected to an inflatable member. The coupler has a chamber internally defining a receiving space for holding the housing member therein and having a fixing end with a plurality of coupling pipes spaced thereon to connect with an air supply device. The air inlet pipes are inserted in the coupling pipes. An external detection system detects the internal pressure of respective coupling pipes to obtain a relative position of the blocked air inlet pipe on the connector, and accordingly regulates the air supplied by the air supply device to control the internal pressure of the inflatable member.

### FIELD OF THE INVENTION

The present invention relates to a connection assembly for air supply device, and more particularly to a connection assembly that includes recognition means to enable an air supply device connected therewith to supply air of a desired pressure for inflating an inflatable member of a specific type.

### BACKGROUND OF THE INVENTION

A bedridden patient, such as a patient who is unable to conveniently move by himself or a patient who just undergoes a surgery, is subjected to slowed blood circulation and accordingly, blood clots, edema or vein thrombosis due to bad blood circulation of limbs, which are farther from the heart. In some worse cases, the bedridden patient is even subjected to necrotic tissue in their limbs.

There is a pneumatic inflatable device currently commercially available in the market for attaching to different body areas. When it is attached to a patient's specific body area and alternatively inflated and deflated by an inflating motor, the pneumatic inflatable device functions to massage and exercise the patient's muscles beneath it to thereby improve the patient's blood circulation.

It is noted the patient's muscles at different body areas require different levels of massaging and exercising. Therefore, a specific air pressure value must be set for the inflating motor each time it is used to inflate and produce an internal air pressure in the pneumatic inflatable device for massaging and exercising a specific body area. It is possible the inflating motor is wrongly set to an unsuitable air pressure value, and it is apparently troublesome and inconvenient for a user to change the setting of the inflating motor each time it is to be used.

In view of the disadvantages in the existing pneumatic inflatable device, it is desirable to develop a connection assembly for air supply device, so that, when the inflating motor inflates a pneumatic inflatable device, the connection assembly enables the air supply device to automatically detect and determine the body area to which the pneumatic inflatable device is currently attached for use, and then automatically control the level of air pressure to be supplied to the pneumatic inflatable device. With the connection assembly, the air supply device is more convenient for use.

### SUMMARY OF THE INVENTION

A primary object of the present invention is to provide a connection assembly for air supply device, so that when an air supply device supplies air to inflate an inflatable member of, for example, a pneumatic inflatable device coupled therewith via the connection assembly, the connection assembly enables a detection system on the air supply device to automatically detect and determine the type of the inflatable member and automatically regulate the supplied air pressure according to the detected type of the inflatable member, so that the alternatively inflated and deflated inflatable member provides proper pressure to massage and exercise a user's selected body area and improve the blood circulation thereof to avoid the occurrence of blood clots and edema.

To achieve the above and other objects, the connection assembly for air supply device according to the present invention includes a connector and a coupler. The connector includes a housing member internally defining an air space. The housing member is provided on an axial end thereof with a plurality of air inlet pipes, which communicate with the air space, and on another axial end thereof with an air outlet pipe, which also communicates with the air space. One of the air inlet pipes is a blocked pipe having a sealed distal end, while all other air inlet pipes are open pipes respectively having an open distal end. The air inlet pipes are provided on around respective distal end with an annular groove for receiving a sealing element therein. The sealing elements can be, for example, rubber O-rings.

The coupler has an end coupled with the connector, and includes a chamber shaped corresponding to the housing member for holding the latter therein. The chamber internally defines a receiving space, of which two axial ends respectively form an open end and a fixing end. And, a plurality of coupling pipes is spaced on the fixing end to receive the air inlet pipes therein and communicate with the open air inlet pipes. Further, the coupling pipes respectively have a diameter-expanded seat section and a diameter-reduced air path section.

In a preferred embodiment of the present invention, the housing member is provided on an outer surface with at least one guide rail, and the chamber is provided on a corresponding inner surface with at least one guide groove for correspondingly engaging with the at least one guide rail, so that the connector can be coupled with the coupler only when the connector's outer surface with the at least one guide rail is oriented to the chamber's inner surface with the corresponding guide groove. That is, the connector can be fitted only one way into the coupler.

The housing member is further provided on two axial lateral outer surfaces with an elongated retaining arm each. The retaining arms respectively have a proximal end connected to the lateral outer surface of the housing member and a free distal end formed into a hook portion and a push portion. And, the chamber has a channel and a retaining hole sequentially provided on each of two axial lateral inner surfaces thereof at positions corresponding to a linear path, along which the retaining arm is moved into the coupler. With these arrangements, an increased connecting force between the connector and the coupler can be ensured when the connector is coupled with the coupler.

The chamber further has a raised portion formed on an outer surface thereof corresponding to each guide groove provided on the chamber's inner surface, and the housing member further has an extended portion formed on around the other axial end adjacent to the air outlet pipe, enabling a user to directly recognize from the outer surfaces of the connector and the coupler the only correct direction for fitting the connector into the coupler without the need of checking the positions of the guide rail and the guide groove.

According to a preferred embodiment of the present invention, the air outlet pipe is formed on a cap. The cap is covered onto the other axial end of the housing member to close the air space, so that air supplied into the air space can flow out of the air space only via the air outlet pipe.

The present invention is characterized in the provision of a connection assembly that has a plurality of blocked and open air inlet pipes formed thereon and is connected with an air supply device, such that when a detection system on the air supply device detects the relative position of the blocked air inlet pipe on the connection assembly via a pressure detection when the supplied air flows from the air supply device via the connection assembly toward an inflatable member connected therewith. According to the detected result, the volume and pressure of air to be supplied from the air supply device to the inflatable unit can be controlled.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a connection assembly for air supply device according to the present invention;

FIG. 2 is a sectional perspective view of FIG. 1;

FIG. 3 shows in phantom view the connection assembly for air supply device according to a first embodiment of the present invention;

FIG. 4 shows in phantom view the connection assembly for air supply device according to a second embodiment of the present invention; and

FIG. 5 shows in phantom view the connection assembly for air supply device according to a third embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

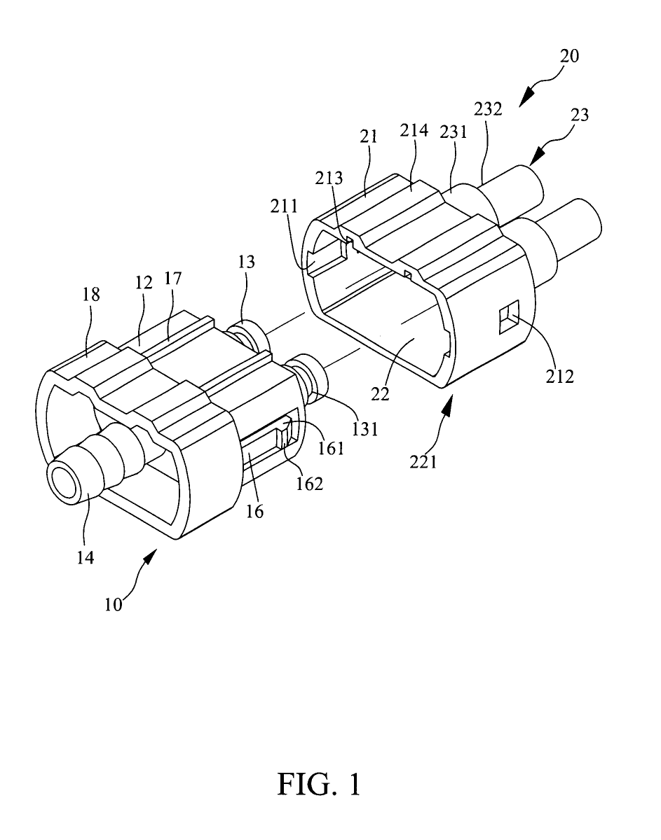

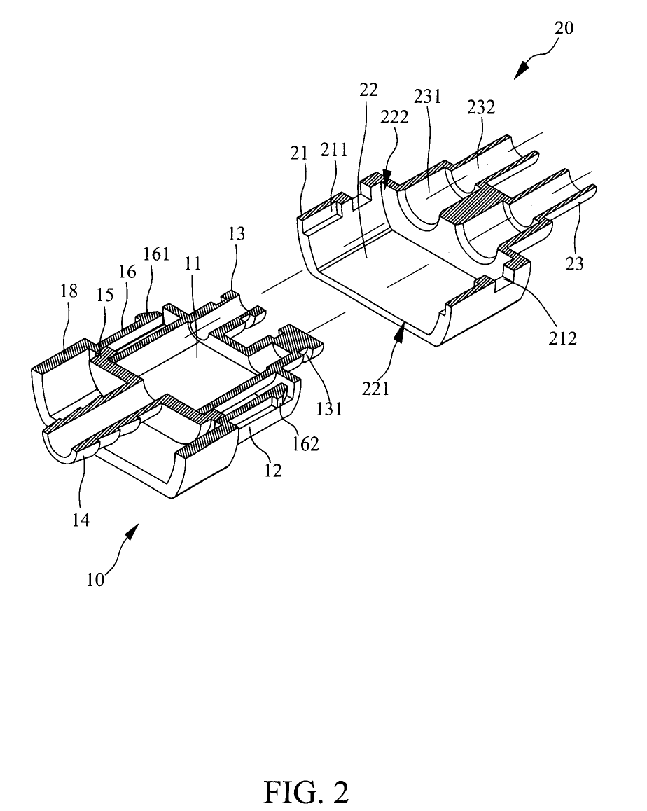

Please refer to FIG. 1 that is an exploded perspective of a connection assembly for air supply device according to the present invention, and to FIG. 2 that is a sectional perspective view of FIG. 1. For the purpose of conciseness and clarity, the present invention is also briefly referred to as the connection assembly herein. As shown, the connection assembly includes a connector 10 and a coupler 20. The connector 10 includes a housing member 12 internally defining an air space 11. The housing member 12 is provided on an axial end thereof with a plurality of air inlet pipes 13, which communicate with the air space 11. A cap having an air outlet pipe 14 formed thereon is covered onto and closes another axial end of the housing member 12, so that air in the air space 11 can flow out of the air space 11 only via the air outlet pipe 14. One of the air inlet pipes 13 is a blocked pipe having a sealed distal end, while all other air inlet pipes 13 are open pipes respectively having an open distal end.

The coupler 20 includes a chamber 21 shaped corresponding to the housing member 12 for holding the latter therein. The chamber 21 internally defines a receiving space 22, of which two axial ends respectively form an open end 221 and a fixing end 222. A plurality of coupling pipes 23 are spaced on the fixing end 222 to receive the air inlet pipes 13 therein and communicate with the open air inlet pipes 13. The coupling pipes 23 respectively have a diameter-expanded seat section 231 and a diameter-reduced air path section 232. The seat section 231 is located between the receiving space 22 and the air path section 232 for the air inlet pipes 13 of the connector 10 to fit therein. The air inlet pipes 13 are provided on around respective distal end with an annular groove 131 for receiving a sealing element therein. The sealing elements can be, for example, rubber O-rings.

The housing member 12 of the connector 10 is further provided on two axial lateral outer surfaces with an elongated retaining arm 16 each. The retaining arms 16 respectively have a proximal end connected to the lateral outer surface of the housing member 12 and a free distal end formed into a hook portion 161 and a push portion 162. On the other hand, the chamber 21 of the coupler 20 has a channel 211 and a retaining hole 212 sequentially provided on each of two axial lateral inner surfaces thereof at positions corresponding to a linear path along which the retaining arm 16 is moved into the coupler 20 from the opening end 221 of the chamber 21. Whereby, when the connector 10 is fitted in the chamber 21, the retaining arms 16 are moved through the two channels 211 with the hook portions 161 and the push portions 162 extending into and becoming engaged with the retaining holes 212. With these arrangements, an enhanced connecting force between the connector 10 and the coupler 20 can be ensured. At this point, the air inlet pipes 13 with the sealing elements mounted thereon are simultaneously extended into the seat sections 231 of the coupling pipes 23, allowing the connector 10 to couple and communicate with the coupler 20.

The housing member 12 is further provided on one outer surface with at least one guide rail 17, and the chamber 21 is provided on a corresponding inner surface with a guide groove 213 for correspondingly engaging with the guide rail 17, so that the connector 10 can be coupled with the coupler 20 only when the connector's outer surface with the at least one guide rail 17 is oriented to the chamber's inner surface with the corresponding guide groove 213. That is, the connector 10 can be fitted only one way into the coupler 20.

The chamber 21 further has a raised portion 214 formed on an outer surface thereof corresponding to each guide groove 213 provided on the chamber's inner surface, and the housing member 12 of the connector 10 further has an extended portion 18 formed on around the axial end adjacent to the air outlet pipe 14. Therefore, a user is able to directly recognize from the outer surfaces of the connector 10 and the coupler 20 the only correct direction for fitting the connector 10 into the coupler 20 without the need of checking the positions of the guide rail 17 and the guide groove 213.

The above described means for increasing the connecting force between the connector 10 and the coupler 20, and means for recognizing the only correct fitting direction of the connector 10 into the coupler 20 are only illustrative to enable easy explanation of the present invention and not intended to limit the present invention in any way. That is, all other means that enable increased connecting force between the connector and the coupler and all other means that enable easy recognition of the correct fitting direction of the connector into the coupler are included in the scope of the present invention.

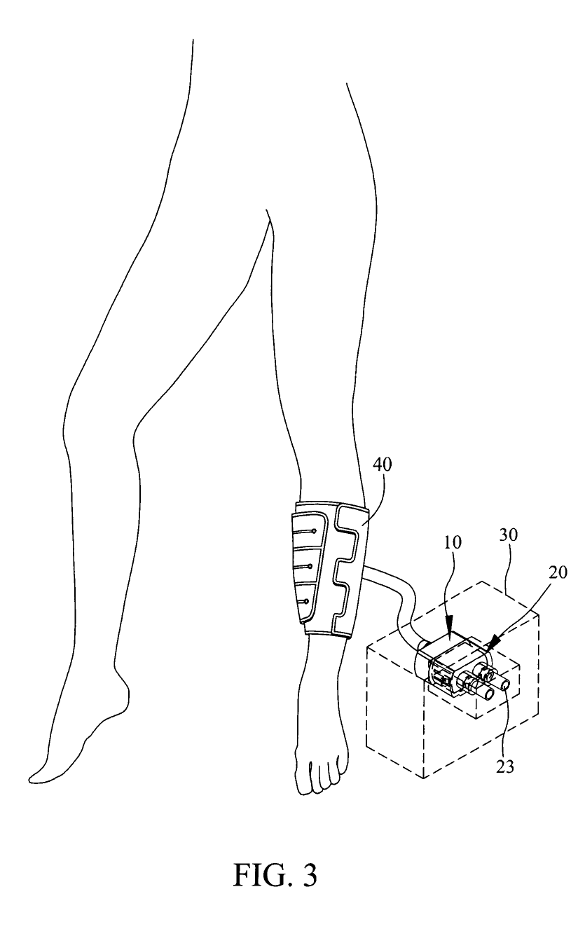

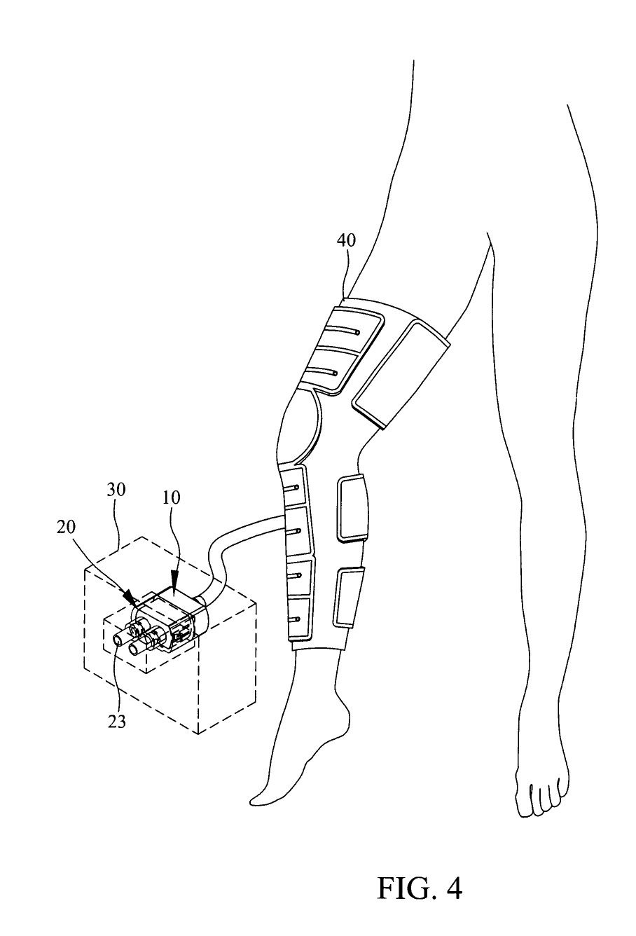

Please refer to FIGS. 3 and 4 that pictorially show a first and a second embodiment of the present invention. As shown, the connection assembly is connected with an air supply device 30 via the coupler 20 and with an inflatable member 40 via the connector 10. According to the first and the second embodiment, the inflatable member 40 can be fitted on around a user's arm and leg, respectively. By inserting the connector 10 in the coupler 20 to form the connection assembly, a type of fluid, such as air, supplied by the air supply device 30 can be delivered through the connection assembly into the inflatable member 40. By alternatively inflating and deflating the inflatable member 40, the inflatable member 40 can provide the effect of massaging and exercising the user's arm or leg.

In the present invention, the air inlet pipes 13 on the connector 10 include both blocked and open pipes. Further, a detection system is mounted on the air supply device 30 and has a plurality of pressure sensors for detecting the pressure level in respective coupling pipes 23. When the supplied fluid, such as air, flows from the coupler 20 to the connector 10, the pressure sensors sense the internal air pressures of respective coupling pipes 23 to determine whether the coupling pipes 23 are fluidly communicable with the air inlet pipes 13 and accordingly obtain the positions of the blocked air inlet pipe 13 or the open air inlet pipes 13 on the connector 10. Further, from the detected positions of the blocked or the open air inlet pipes 13 on the connector 10, the detection system is able to determine whether the inflatable member 40 being connected to the connector 10 is configured for use with the arm, the leg or other body area, and then provides information about the type of the inflatable member 40 to the air supply device 30 and the coupler 20, so that the air supply device 30 and the coupler 20 control the flow of the supplied fluid, such as air, and accordingly the internal pressure of the inflatable member 40, enabling the alternatively inflated and deflated inflatable member 40 to exactly massage and exercise the patient's muscles.

To enable clear description of the present invention, the first embodiment pictorially shown in FIG. 3 has a left and a right air inlet pipe 13 provided on the connector 10. When the detection system detects that the left air inlet pipe 13 is a blocked pipe and the right air inlet pipe 13 is an open pipe, the detection system would inform the air supply device 30 and the coupler 20 that the inflatable member 40 currently connected to the connector 10 is configured for use with a user's calf, and air with pressure suitable for massaging and exercising calf muscles is supplied from the air supply device 30 to inflatable member 40 for the latter to massage and exercise the user's calf muscles and improve the blood circulation thereof.

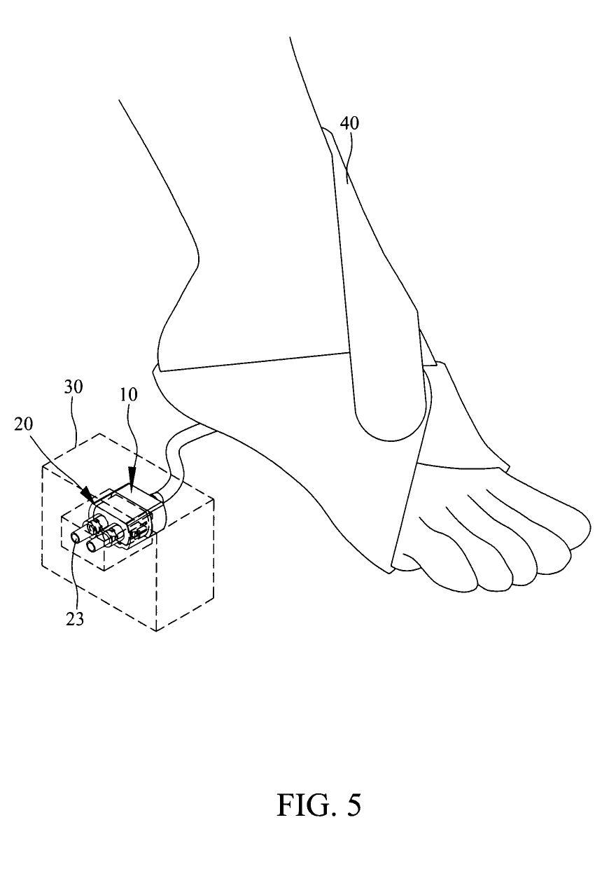

On the other hand, in the second embodiment of the present invention pictorially shown in FIG. 4, when the detection system detects the left air inlet pipe 13 is an open pipe and the right air inlet pipe is a blocked pipe, the detection system would inform the air supply device 30 and the coupler 20 that the inflatable member 40 currently connected to the connector 10 is configured for use with a user's whole leg, and air with pressure suitable to massaging and exercising all the leg muscles is supplied from the air supply device 30 to the inflatable member 40 for the latter to massage and exercise the whole leg's muscles and improve the blood circulation thereof. FIG. 5 pictorially shows another operable embodiment of the present invention for connecting to an inflatable member 40 that is used with a user's foot to massage and exercise the foot muscles and improve the blood circulation thereof.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A connection assembly for air supply device being used to connect an inflatable member to an air supply device, comprising:
a connector including a housing member internally defining an air space; the housing member being provided on an axial end thereof with a plurality of air inlet pipes, which communicate with the air space, and on another axial end thereof with an air outlet pipe, which also communicates with the air space; and
one of the air inlet pipes being a blocked pipe having a sealed distal end, while all other air inlet pipes being open pipes respectively having an open distal end; and
a coupler including a chamber shaped corresponding to the housing member for holding the latter therein; the chamber internally defining a receiving space, of which two axial ends respectively forming an open end and a fixing end; and a plurality of coupling pipes being spaced on the fixing end for receiving the air inlet pipes therein and communicating with the open air inlet pipes.

2. The connection assembly for air supply device as claimed in claim 1, wherein the housing member is provided on an outer surface with at least one guide rail, and the chamber is provided on a corresponding inner surface with at least one guide groove for correspondingly engaging with the at least one guide rail.

3. The connection assembly for air supply device as claimed in claim 1, wherein the housing member is provided on two axial lateral outer surfaces with an elongated retaining arm each; the retaining arms respectively having a proximal end connected to the lateral outer surface of the housing member and a free distal end formed into a hook portion and a push portion; and the chamber having a channel and a retaining hole sequentially provided on each of two axial lateral inner surfaces thereof at positions corresponding to a linear path, along which the retaining arm is moved into the coupler.

4. The connection assembly for air supply device as claimed in claim 1, wherein the air inlet pipes are provided on around respective distal end with an annular groove.

5. The connection assembly for air supply device as claimed in claim 2, wherein the chamber further has a raised portion formed on an outer surface thereof corresponding to each guide groove provided on the chamber's inner surface, and the housing member further having an extended portion formed on around the other axial end adjacent to the air outlet pipe.

6. The connection assembly for air supply device as claimed in claim 1, wherein the coupling pipes respectively have a diameter-expanded seat section and a diameter-reduced air path section.

7. The connection assembly for air supply device as claimed in claim 1, wherein the air outlet pipe is formed on a cap; and the cap being covered onto the other axial end of the housing member to close the air space, so that air supplied into the air space can flow out of the air space only via the air outlet pipe.
